(19) United States
(12) Patent Application Publication
(10) Pub. No.: US 2007/0153443 A1
(43) Pub. Date: Jul. 5, 2007

(54) Method and apparatus for preemptively detecting fan failure in an electronic system

(75) Inventors: Alan Michael Lyons, Malahide (IE); Alan David O'Loughlin, Dublin (IE)

Correspondence Address: WILLIAMS, MORGAN & AMERSON, 10333 RICHMOND, SUITE 1100, HOUSTON, TX, 77042, US

(73) Assignee: LUCENT TECHNOLOGIES, INC.

(21) Appl. No.: 11/323,306

(22) Filed: Dec. 31, 2005

(51) Int. Cl. H02H 5/04

(52) U.S. Cl. 361/103

(57) ABSTRACT

A method for preemptively detecting fan failure is provided. The method may include measuring at least one parameter associated with the fan, such as sound, wobble, smoke, or the like, and predicting a time at which failure of the system is anticipated based on said measured parameter. Thereafter an indication of the predicted time at which failure of the system is anticipated is provided. Maintenance of the system to repair or replace the fans may then be scheduled as part of a regularly scheduled maintenance call, reducing the cost associated with the fan failure.

### BACKGROUND OF THE INVENTION

1. Field of the Invention

This invention relates generally to electronic systems, and, more particularly, to scheduling maintenance of components within an electronic system.

2. Description of the Related Art

During the operation of modern electronic equipment, substantial internal heat is generated, which, if not dissipated, can have significant deleterious effects on the equipment. Electrical fans are commonly used to dissipate this heat. Depending on the equipment and application, failure of a fan in a system can have a catastrophic impact on system performance, and, in some cases, can result in the entire system shutting down or otherwise failing.

Like all equipment, fans have a useful life. Typical fan lifetimes are less than 60,000 hours (˜7 years) for high quality fans. In telecommunications equipment with 10-20 year lifetime, even these high quality fans are likely to fail before any other component. In large systems that dissipate substantial heat, multiple fans are typically deployed to provide adequate air flow. These fans are often arranged in a tray that may be operated by one or more controllers. To accommodate the likely failure of one or more fans in the tray, fan trays are designed such that when one fan fails, the speed of the remaining fans is increased to compensate (at least in part) for the loss of air flow. Thus, fan trays are commonly designed to have inherent excess capacity to compensate for fan failures. Fan trays with excess capacity are costly and inefficient.

When a fan fails in the field, a technician is typically dispatched to replace the fan tray. Because electronic systems often cannot tolerate extended operation with inadequate cooling air flow, a service trip is typically scheduled soon after the failure occurs. Thus, the service trips may occur on short notice and not during other routine servicing of the system. Service trips, especially unscheduled service trips, are expensive (especially in the case of remote wireless base stations).

### SUMMARY OF THE INVENTION

The present invention is directed to addressing the effects of one or more of the problems set forth above. The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

In one aspect of the present invention, a method is provided that may include measuring at least one parameter of a system, and predicting a time at which failure of the system is anticipated based on said measured parameter. Thereafter an indication of the predicted time at which failure of the system is anticipated is provided.

### BRIEF DESCRIPTION OF THE DRAWINGS

The invention may be understood by reference to the following description taken in conjunction with the accompanying drawings, in which like reference numerals identify like elements, and in which:

FIG. 1 conceptually illustrates a front view of at least a portion of one exemplary embodiment of a fan tray, in accordance with the present invention;

FIG. 2 conceptually illustrates deviation that may occur in the operation of a fan;

FIG. 3 conceptually illustrates a side view of one embodiment an exemplary fan of FIG. 1 with various sensors disposed thereon;

FIG. 4 conceptually illustrates a front view of one embodiment an exemplary fan of FIG. 1 with various sensors disposed thereon;

FIG. 5 conceptually illustrates a control system that may be employed in accordance with the present invention;

FIG. 6 conceptually illustrates a flow chart representation of one embodiment of a control strategy that may be employed in the control system of FIG. 5;

FIG. 7 conceptually illustrates a flow chart representation of an alternative embodiment of a control strategy that may be employed in the control system of FIG. 5; and

FIG. 8 conceptually illustrates a flow chart representation of an alternative embodiment of a control strategy that may be employed in the control system of FIG. 5.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, ie., a meaning other than that understood by skilled artisans, such a special definition will be expressly set forth in the specification in a definitional manner that directly and unequivocally provides the special definition for the term or phrase.

Generally, in one embodiment of the instant invention, sensors and a control system are provided to predict or anticipate an impending failure of a fan or fan system so that it may be replaced or serviced in a timely manner. The sensors may take any of a variety of forms, including, but not limited to, optical sensors, acoustic sensors, temperature sensors, and the like. The controller may also take any of a variety of forms, including, but not limited to, a microprocessor, a micro-controller, a computer, a hard-wired logic device, a programmable logic device, and the like.

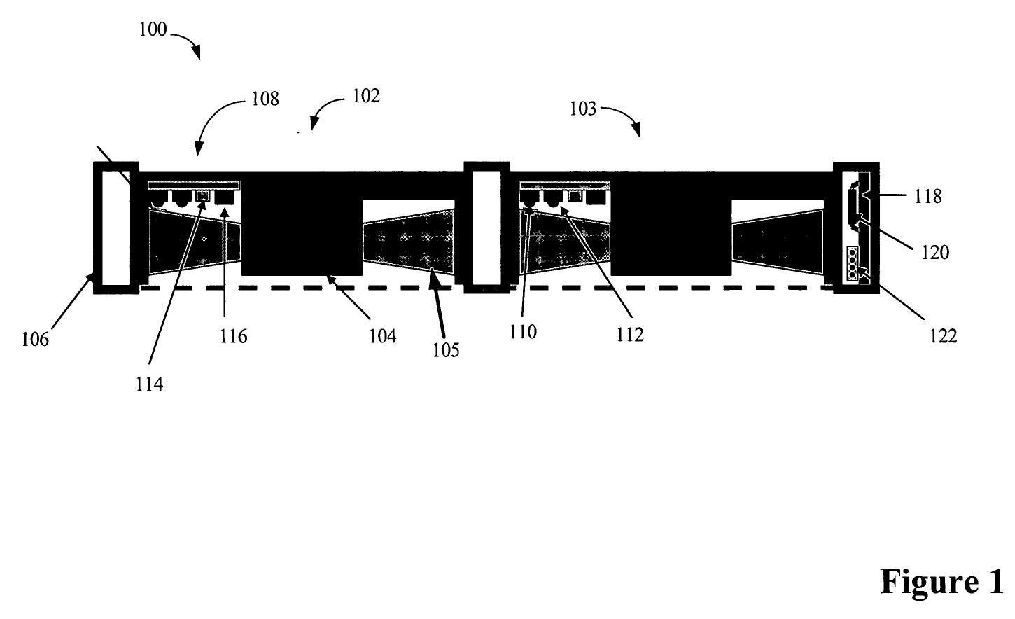

FIG. 1 conceptually illustrates one exemplary embodiment of a fan tray 100. In the illustrated embodiment, the fan tray 100 is shown with a first fan 102 and a second fan 103. Those skilled in the art will appreciate that the principles of the instant invention may find application to systems that include a wide variety of numbers of fans, including one or more fans. Moreover, persons of ordinary skill in the art should appreciate that the present invention is not limited to the illustrated exemplary embodiment. The fans 102, 103 are conventional electrically operated fans generally comprised of a motor 104 and blades 105.

In the illustrated embodiment, the fans 102, 103 are arranged in a tray or housing 106 that may be positioned within a rack or piece of electronic equipment, such as telecommunications equipment (not shown). Generally, the tray 106 is removable and may be replaced during servicing, which may occur at a regularly scheduled time when sensors 108 indicate that a failure is likely to occur in the near future. In the illustrated embodiment, the sensors 108 may take the form of a light source 110, such as a Light Emitting Diode (LED), a photodiode 112, such as a Positive-Intrinsic-Negative (PIN) diode, a temperature sensor 114, and an acoustic sensor 116, such as a low-cost commercially available microphone, similar to those used in cell phones.

Operation of the fans 102, 103 is generally overseen or controlled by a fan controller board 118, which may be comprised of various semiconductor devices 120, which may operate under hard-wired logic control, software control, or a combination thereof. The fan controller board 118 may also be configured with an alarm 122, which may take any of a variety of electrical, optical or acoustic forms to provide an indication of when a fault has been detected or when a fault is predicted.

Generally, the controller board 118 monitors one or more of the sensors 110, 112, 114, 116, and uses information obtained therefrom to predict when a failure of one or more of the fans 102, 103 is likely to occur. Those skilled in the art will appreciate that the fan motor 104 has a rotor (not shown) that is supported by and spins in one or more bearings (not shown). Contact between the spinning rotor and the bearings causes at least one of the parts, such as the bearings, to wear. The microphone 116 may be used to detect bearing wear through characteristic sound patterns. That is, the controller board 118 monitors the output signal from the microphone 116 for a pattern that has been previously associated with bearing wear. The controller board 118 may be used to achieve one or more levels of detection. That is, the controller board 118 may be configured to identify a first noise pattern associated with a first level of bearing wear and a second noise pattern associated with a second level of bearing wear. The first and second levels of bearing wear may be associated with different types of wear or different levels of wear. That is, the controller board 118 may be configured to look for signature of failure by comparing a current noise signal to know failure patterns.

Alternatively, the controller board 118 may be configured to: look for changes in the noise pattern, or monitor change in the noise pattern versus time. That is, the controller board 118 may monitor the signal from the microphone 116 to identify a particular change or any significant change. In an alternative embodiment, the controller board 118 may use noise filtering to predict a failure of the fans 102, 103. The controller board 118 may compare signals from each of the fans 102, 103 and monitor any differences or changes of the acoustic signals associated with each fan. For example, as the fan 102 begins to experience bearing wear, its acoustic signal may vary from that of the fan 103. The difference in acoustic signals between the two fans 102, 103 may be used by the controller board 118 to predict a failing fan and schedule servicing.

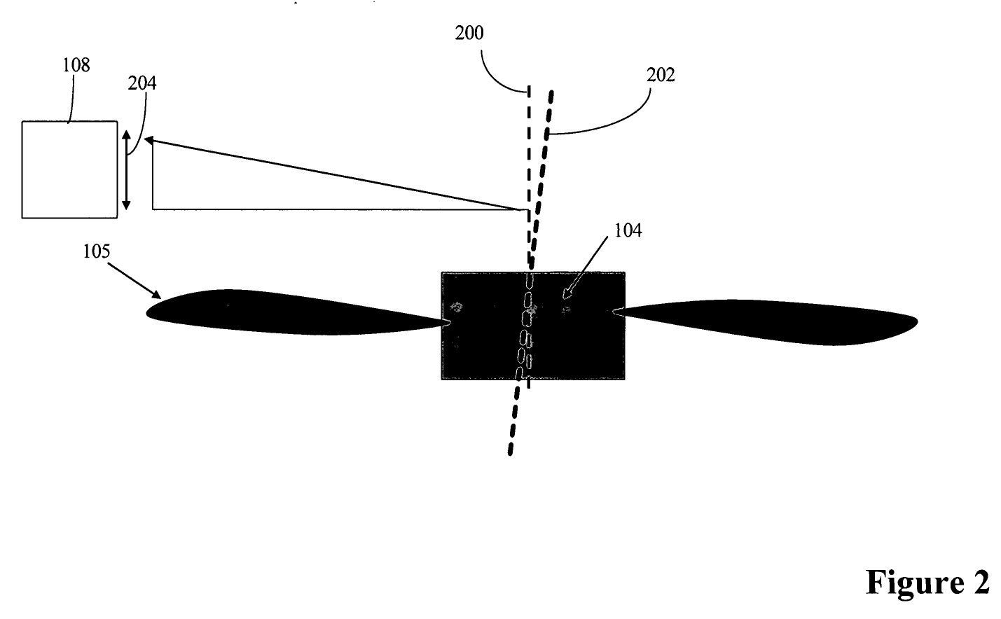

Turning now to FIG. 2, a stylistic side view of the fan 102 is shown. Those skilled in the art will appreciate that the blades 105 spin on an axis 200 that is generally fixed and controlled by the orientation of the rotor (not shown) and bearings (not shown) in the motor 102. As the bearings wear, a new axis 202 may be formed, or the rotor may be allowed to wobble between the original and new axes 200, 202 as the blades 105 rotate at high speed. This variation in the axes 200, 202 induces movement or tip 204 of the blades 105, which can be measured by the sensors 108 and used by the controller board 118 to predict a failure of the fan 102.

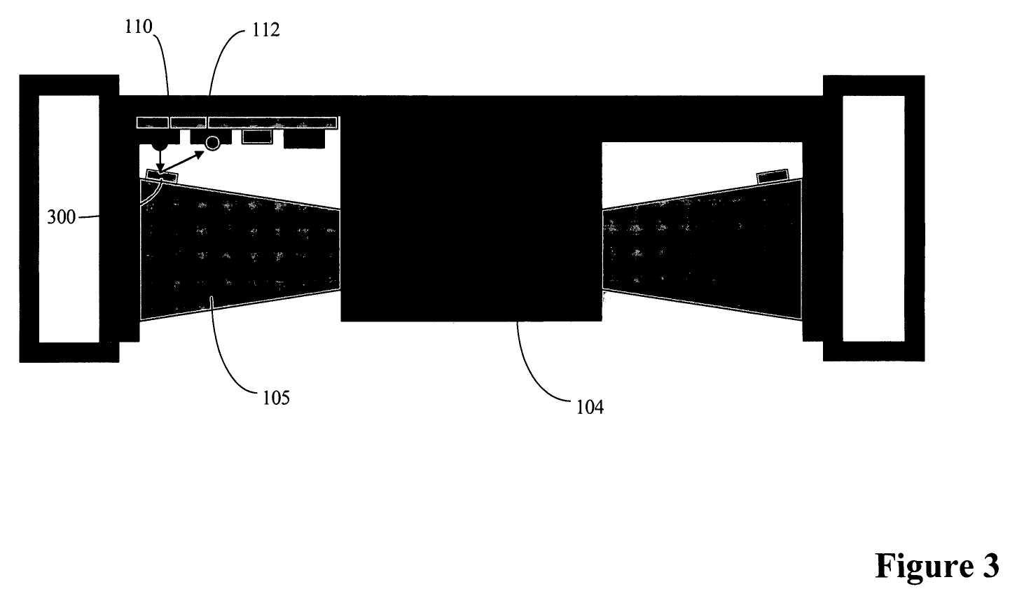

Turning now to FIG. 3, an alternative embodiment of the instant invention is show in which the LED 110 and PIN diode 112 are used by the controller board 118 to detect bearing wear by monitoring blade tip. Generally, light transmitted from the LED 110 impinges onto a reflective element 300 positioned on the fan blade 105 and is reflected/scattered to the PIN diode 112. Changes in the location of the reflected light, as determined by the PIN diode 112 are indicative of changes in position of fan blade 105, and thus, bearing wear. Those skilled in the art will appreciate that as blade tip changes, the reflected light will move relative to the PIN diode 112, causing less light to fall on the PIN diode 112 thereby reducing the magnitude of the signal delivered from the PIN diode 112. The controller board 118 may be programmed to interpret a signal that falls below a preselected magnitude as indicative that the fan 102 is likely to fail in the near future and should be serviced.

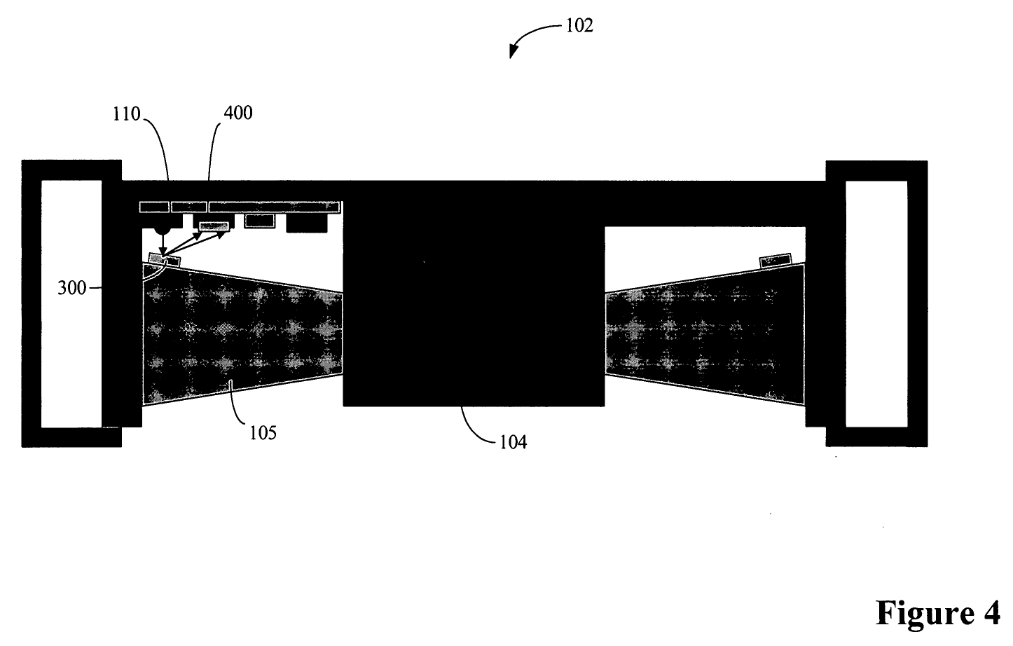

The embodiment illustrated in FIG. 3 employs a single discrete optical sensor (e.g., PIN diode 112). FIG. 4 illustrates an alternative embodiment of the instant invention in which the optical sensor is comprised of an array of optically sensitive elements, such as Charge Coupled Device (CCD) array optical receiver 400 or an array of discrete optical sensors. Using the CCD array optical receiver 400 allows the controller board 118 to determine positional changes of the reflected light, which may more accurately reflect the amount of blade tip being experienced by the fan blades 105.

The optical sensor may also be used to detect the presence of smoke. Smoke is an early indication of a significant thermal and/or electrical failure. The presence of smoke reduces the overall intensity of the reflected optical signal. The controller board 118 could be programmed to detect the presence of smoke in response to the intensity of the reflected optical signal falling below a preselected value. The presence of smoke may be a sole or additional factor that the controller board utilizes to predict a failure of at least one fan 102, 103 in the fan tray 100.

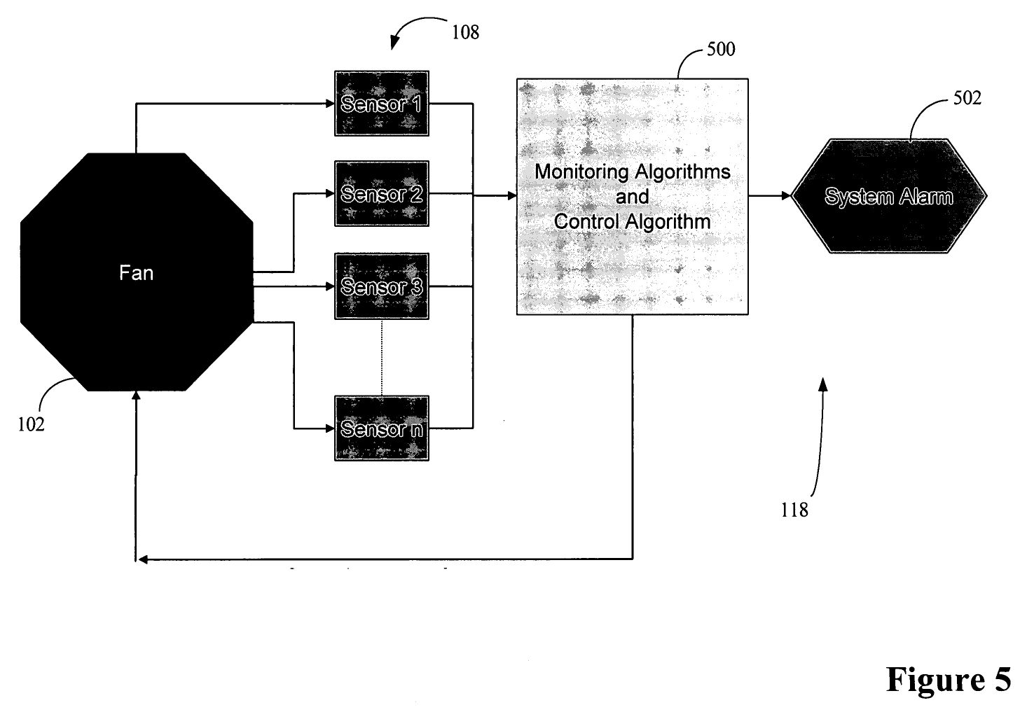

Turning now to FIG. 5, a stylistic representation of logical interconnections between the controller board 118, the fan 102 and the sensors 108 are shown. The sensors 108 are shown receiving various signals from the fan 102. As discussed above, these various signals may take the form of optical signals, acoustic signals, temperature signals, and the like, and may be used to monitor preselected parameters associated with the operation of the fan 102. The parameters monitored by the sensors 108 are delivered to the controller board 118, and are supplied to monitoring/control algorithms 500 that analyze the parameters and predict fan failure based thereon. Those skilled in the art will appreciate that the algorithms 500 may take the form of software, hardware, or a combination thereof. The algorithms 500 then provide an electrical signal to a system alarm 502. The system alarm 502 can take on any of a variety of forms, such as an audio or optical system that indicates the anticipated remaining life of the fan 102, or an indication that the fan 102 should be scheduled for servicing.

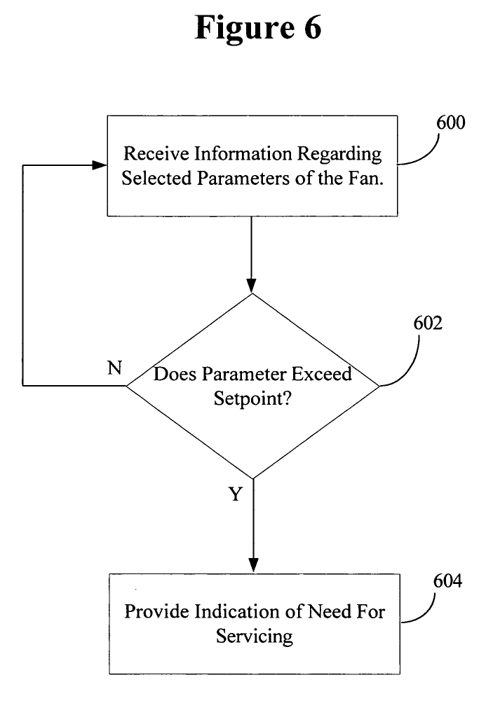

An exemplary embodiment of a software routine that may be employed as the monitor/control algorithm 500 is shown in a flowchart representation in FIG. 6. In the illustrated embodiment, the algorithm 500 utilizes information provided by the optical sensor to predict remaining life or failure time of the fan 102. In particular, the process begins at block 600 with the control board 118 receiving information from the optical sensor. In one exemplary embodiment, the received optical information relates to the degree of tilt or wobble being experienced by the fan 102. At block 602, the detected tilt of the fan 102 is compared with a preselected value that may have been theoretically or empirically determined to represent a tilt value at which failure of the fan is relatively imminent. If the determined tilt exceeds the preselected value, then control transfers to block 604 where the control algorithm provides a signal indicating that the fan 102 is in need of servicing.

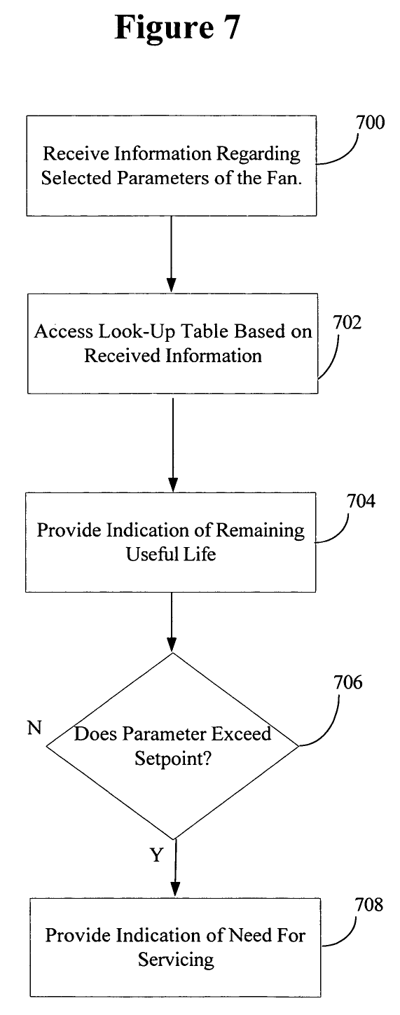

An alternative exemplary embodiment of a software routine that may be employed as the monitor/control algorithm 500 is shown in a flowchart representation in FIG. 7. In the illustrated embodiment, the algorithm 500 utilizes information provided by the optical sensor to predict remaining life or failure time of the fan 102. In particular, the process begins at block 700 with the control board 118 receiving information from the optical sensor. In one exemplary embodiment, the received optical information relates to the degree of tilt or wobble being experienced by the fan 102. At block 702, the detected tilt of the fan 102 is used to access a look-up table that contains information correlating remaining useful life or failure time to tilt. For example, the look-up table may correlate tilt to remaining useful life as set forth in Table I below.

TABLE I

| | REMAINING |
|---|---|
| TILT (DEGREES) | USEFUL LIFE (%) |
| 1 | 95 |
| 2 | 90 |
| 3 | 60 |
| 4 | 20 |

Thereafter, at block 704, the control algorithm 500 may provide an indication of the remaining useful life of the fan 102. For example, if a tilt of 3 degrees is measured, then the control algorithm may select to deliver a signal indicating that the fan 102 has a remaining useful life of 60% . The control routine may compare the determined remaining useful life to determine if servicing of the fan 102 should be scheduled. For example, at block 706, if the remaining useful life falls below a preselected setpoint (e.g., 20%), then an indication may be provided that servicing of the fan 102 should be scheduled, block 708.

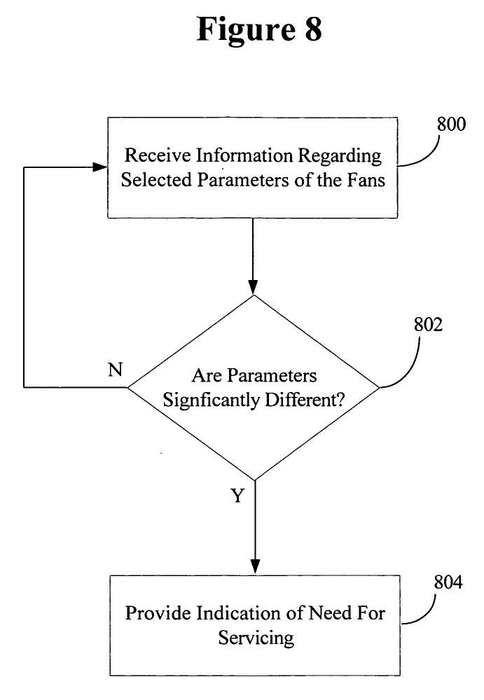

An alternative exemplary embodiment of a software routine that may be employed as the monitor/control algorithm 500 is shown in a flowchart representation in FIG. 8. In the illustrated embodiment, the algorithm 500 utilizes information provided by the acoustic sensor to predict remaining life or failure time of the fans 102, 103. In particular, the process begins at block 800 with the control board 118 receiving information from the acoustic sensors associated with the fans 102, 103. In one exemplary embodiment, the received acoustic information relates to the noise being produced by the fans 102, 103. At block 802, the noise produced by the fan 102 is compared to the noise produced by the fan 103 to determine if a significant difference occurs. If the noise produced by the fans 102, 103 is significantly different, then control transfers to block 804 where the control algorithm 500 provides a signal indicating that at least one of the fans 102, 103 is in need of servicing. To determine if the noise is significantly different, a number of factors may be considered. For example, the control algorithm 500 may compare the magnitude of noise at one or more preselected frequency ranges. Alternatively, the control algorithm may determine the difference in the overall level of noise produced by the fans 102, 103. The degree of difference that is used to determine when the noise is significantly different may be determined empirically or theoretically.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method, comprising:
measuring at least one parameter of a system;
predicting a time at which failure of the system is anticipated based on said measured parameter; and
providing an indication of the predicted time at which failure of the system is anticipated.

2. A method, as set forth in claim 1, further comprising scheduling maintenance of the system based at least in part on the predicted failure time.

3. A method, as set forth in claim 1, wherein measuring at least one parameter of a system further comprises measuring sound generated by operation of at least one fan.

4. A method, as set forth in claim 3, wherein predicting the time at which failure of the system is anticipated based on said measured parameter further comprises comparing the measured sound of the fan to at least one sound pattern associated with an impending failure of a fan.

5. A method, as set forth in claim 4, wherein predicting the time at which failure of the system is anticipated based on said measured parameter further comprises identifying a substantial match between the measured sound to the at least one sound pattern associated with the impending failure of a fan.

6. A method, as set forth in claim 3, wherein predicting the time at which failure of the system is anticipated based on said measured parameter further comprises comparing the measured sound of the fan to the sound of a properly operating fan.

7. A method, as set forth in claim 6, wherein predicting the time at which failure of the system is anticipated based on said measured parameter further comprises identifying any substantial difference between the measured sound and the sound of the properly operating fan.

8. A method, as set forth in claim 1, wherein measuring at least one parameter of a system further comprises measuring wobble of the fan.

9. A method, as set forth in claim 8, wherein predicting the time at which failure of the system is anticipated based on said measured parameter further comprises associating the measured wobble of the fan with an impending failure of the fan.

10. A method, as set forth in claim 9, wherein predicting the time at which failure of the system is anticipated based on said measured parameter further comprises comparing the measured wobble to a preselected setpoint.

11. A method, as set forth in claim 8, wherein predicting the time at which failure of the system is anticipated based on said measured parameter further comprises comparing the measured wobble of the fan to the wobble of a properly operating fan.

12. A method, as set forth in claim 11, wherein predicting the time at which failure of the system is anticipated based on said measured parameter further comprises identifying any substantial difference between the measured wobble and the wobble of the properly operating fan.

13. A method, as set forth in claim 8, wherein measuring wobble of the fan further comprises measuring the degree of wobble in the fan.

14. A method, as set forth in claim 13, wherein predicting the time at which failure of the system is anticipated based on said measured parameter further comprises correlating the degree of wobble to an anticipated remaining useful life of the fan.

15. A method, as set forth in claim 14, wherein correlating the degree of wobble to an anticipated remaining useful life of the fan further comprises accessing a look-up table using the degree of wobble to locate an entry related to the remaining useful life of the fan.

16. A method, as set forth in claim 1, wherein measuring at least one parameter of a system further comprises measuring smoke emitted from the fan.

17. A method, as set forth in claim 16, wherein predicting the time at which failure of the system is anticipated based on said measured parameter further comprises associating the presence of smoke with an impending failure of the fan.

18. A method, as set forth in claim 1, wherein measuring at least one parameter of a system further comprises measuring sound generated by operation of a first and second fan.

19. A method, as set forth in claim 18, wherein predicting the time at which failure of the system is anticipated based on said measured parameter further comprises comparing the measured sound of the first and second fan.

20. A method, as set forth in claim 19, wherein predicting the time at which failure of the system is anticipated based on said measured parameter further comprises identifying a substantial difference in the measured sounds of the first and second fans.
